(19) United States
(12) Patent Application Publication
(10) Pub. No.: US 2024/0054514 A1
(43) Pub. Date: Feb. 15, 2024

(54) AUTOMATED VALUATION OF AN EXHIBITION BOOTH

(71) Applicant: Zoho Corporation Private Limited, Chengalpattu Taluk (IN)

(72) Inventors: Manikanda Vignesh Soundararajan, Salem (IN); Sridhar Pazhayannur Gopalakrishnan, Tenkasi (IN); Vijaykumar Rajendran, Chennai (IN); Anjana Venkatachalam, Chennai (IN); Punithavathi Palani, Chennai (IN)

(21) Appl. No.: 18/446,449

(22) Filed: Aug. 8, 2023

Related U.S. Application Data
(60) Provisional application No. 63/378,545, filed on Oct. 6, 2022.

(30) Foreign Application Priority Data
Aug. 9, 2022 (IN) 202241045447
Jul. 27, 2023 (IN) 202341050767

(51) Int. Cl. G06Q 30/0201; G06Q 30/0202

(52) U.S. Cl. CPC G06Q 30/0206; G06Q 30/0202

(57) ABSTRACT

Described are systems and methods of an exhibition management system that automatically creates, maintains, valuates and re-valuates a booth in a venue. Automated valuation and re-valuation is a process of determining an optimal value for the booth. Based on various factors and subsystems, the optimal value is determined. The booth value thus determined is projected to the organizers, prospective exhibitors for sale. Automating such a system increases the booth value, brings in more prospective exhibitors and facilitates (reduces) the manual process carried out by the organizers of such an exhibition.

### CROSS-REFERENCE TO RELATED APPLICATIONS

The present application claims priority from Indian Provisional Application No. 202241045447 filed Aug. 9, 2022, Indian Provisional Application No. 202341050767 filed Jul. 27, 2023, and U.S. Provisional Patent Application Ser. No. 63/378,545 filed Jun. 10, 2023, each of which is incorporated herein by reference.

### BACKGROUND

Exhibits provide a marketing environment that surrounds the business and influence its marketing operations. The success of managing an exhibition depends on its detailed planning, organizing and execution. Planning, executing and managing exhibits is a challenge for most organizers.

### SUMMARY

A booth area valuation is initiated by booth area valuation before booth sale using distance metrics and later by upsurging an unsold booth value using neighborhood properties, one example of which is a reputation of an organization. The price is set for the obtained booth value and is projected to organizers, prospective exhibitors for sale.

### BRIEF DESCRIPTION OF THE DRAWINGS

FIG. 1 depicts a block diagram of an example of an exhibition management system architecture.

FIG. 2 depicts a block diagram of an example of a booth management subsystem architecture.

FIG. 3 illustrates a flowchart of an example of a method for booth combination.

FIG. 4 depicts a flowchart of an example of a method to determine proximity value of each booth before sale.

FIG. 5 depicts tabulated values of an organization reputation score and its corresponding reputation value weightage.

FIG. 6 depicts a flowchart of an example of a method for re-valuation of an unsold booth.

FIG. 7 depicts a flowchart of an example of a method for re-valuation of a sold booth.

FIG. 8 depicts a screenshot for valuation and re-valuation of persistent booths.

FIG. 9 depicts a screenshot for valuation and re-valuation of slot wise validity booths on Day 1.

FIG. 10 depicts a screenshot for valuation and re-valuation of combination booths on Day 2.

FIG. 11 depicts a screenshot illustrating a display of high visibility booths based on exhibitor or user preference.

FIG. 12 depicts a screenshot illustrating a display of booths located near spots.

FIG. 13 depicts a screenshot for facilitating determination of booths based on a real world customization and a venue reactive parameter.

FIG. 14 illustrates a trend graph with a feedback of an upsurge booth value displayed to an exhibitor based on re-valuation over a periodic time interval.

### DETAILED DESCRIPTION

In this paper, the disclosed method for valuation and re-valuation works well for both pre available venues where events are frequently being conducted, and for new venues where the event has never happened before. Booths described in this paper can be open booths or closed booths. Moreover, the term booth can be generalized as a 2-dimensional area or 3-dimensional space (“zone object”) that has parameters shared across other zone object instances within a venue, with variable scores (some of which may or may not have a null score) that depend upon size, location, environmental, and other inherent or influencing factors identified as relevant within the venue. A disclosed dynamic revaluation of booth provides a hike in, e.g., booth value based on neighboring booth reputation and influencing factors of the booth.

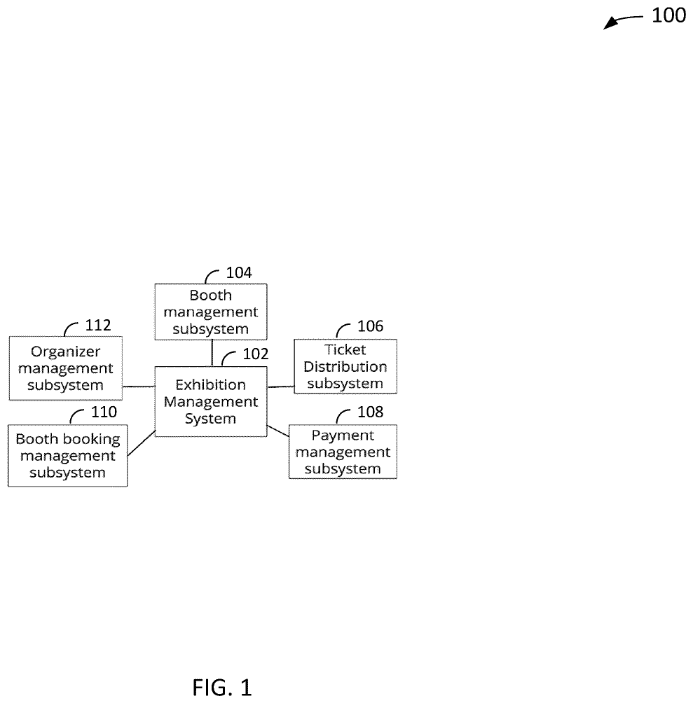

FIG. 1 depicts a block diagram 100 of an example of an exhibition management system architecture. The exhibition management system 102 is the central component that manages the exhibition and the booth allocation. FIG. 1 includes a booth management subsystem 104, a ticket distribution subsystem 106, a payment management subsystem 108, a booth booking management subsystem 110, and an organizer management subsystem 112 wherein the subsystems are coupled to the exhibitor management system 102. Each of the subsystems has its own data store to store and retrieve exhibition related information.

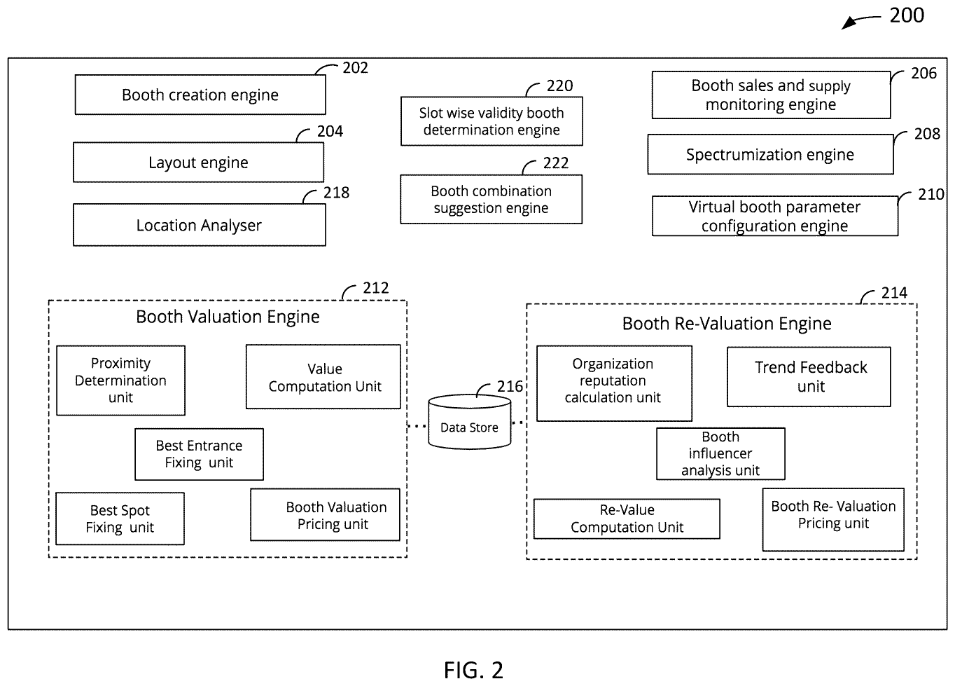

The booth management subsystem 104 is intended to represent a subsystem that manages and updates the booths, floor maps, access to view and manages prospective exhibitors, customizes booth pricing based on booth valuation and re-valuation. The booth management subsystem 104 manages and sorts booths based on categories such as persistent booths and slot wise validity booths and merges booths based on booth availability using booth combination methods. The booth management subsystem is described in more detail later in FIG. 2.

The ticket distribution subsystem 106 is intended to represent a subsystem that involves the booking, purchasing and distribution mechanisms that link the exhibition, prospective exhibitors and attendees.

The payment management subsystem 108 is intended to represent a subsystem that organizes and manages billing and payment processes of an exhibition. The payment management subsystem 108 receives, manages and makes payments associated to the exhibition.

The booth booking management subsystem 110 is intended to represent a subsystem where prospective exhibitors can manage their own booking. The booth booking management subsystem 110 facilitates real time data access and updates as new bookings are made.

The organizer management subsystem 112 is intended to represent a subsystem that assists organizers in conceptualizing themes, planning budgets, booking venues, liaising with suppliers and clients, monitoring activities, managing logistics, and presenting post-event reports.

FIG. 2 depicts a block diagram 200 of an example of a booth management subsystem architecture. FIG. 2 includes a booth creation engine 202, a layout engine 204, a booth sales and supply monitoring engine 206, a spectrumization engine 208, a virtual booth parameter configuration engine 210, a booth valuation engine 212, and a booth re-valuation engine 214. The booth valuation engine 212 and the booth re-valuation engine 214 are coupled to a datastore 216. The block diagram 200 also includes a location analyzer 218, a slot wise validity booth determination engine 220, and a booth combination suggestion engine 222.

The layout engine 204 divides the whole area of a venue hall into small sections to form a layout. It creates floor maps using layout for navigation and for placement of booths in a relative position. The layout engine 204 forms a venue layout and a booth layout. A booth layout includes booths and spots. The layout engine 204 facilitates organizer to decide venue and booth layout. After sale of a booth, the layout engine 204 facilitates a booth exhibitors to decide booth layout wherein multiple sub brands can be exhibited in their respective booths.

The booth creation engine 202 is intended to represent an engine that identifies booths and spots from the layout. Spots are non-booth areas in a layout. As an example, a staircase at the venue hall is a spot where a booth cannot be constructed. The booth creation engine 202 is intended to categorize booths based on categories such as persistent booths and slot wise validity booths. The categorization is based on a predetermined input from the exhibition organizer. Each booth and each spot is given a unique identification. The unique identification is a number, an alphabet or an alpha numeric character. A booth unique identification or a spot unique identification is a number or alphabet or alpha numeric characters assigned by the system to identify an exhibitor's floor space. Each exhibitor will receive the unique identification which will coincide with the exhibition floor plan map. The assigned booth or spot unique identification is stored in a data store to identify a booth or a spot, to identify a booth or a spot position during valuation and re-valuation, to identify the booth value or a booth value neighboring to a spot, to identify one or more asset associated to a booth or a spot, to identify influential factors (such as an air conditioner temperature in and around the booth area, connectivity to a Wi-Fi network) to a booth or a spot. Each brand and sub brand of the brand owned by an exhibitor of a booth is identified with a unique identification. Based on the unique identification of a booth its associated price is obtained from a price list.

The booth sales and supply monitoring engine 206 is intended to represent an engine that monitors a sold and an unsold status of a booth, and monitors and facilitates booth infrastructure supply and additional facilities for a booth. Inventory information such as infrastructure supply are stored in a data store. The monitored inventory information may be used during billing by the payment management subsystem. The booth sales and supply monitoring engine 206 possesses a booth status recorder. The booth status recorder stores information related to the sold and unsold status of a booth.

The spectrumization engine 208, based on the booth valuation engine 212 and the booth re-valuation engine 214, categorizes booths into different zones and uses a color coding to represent proximity value and re-value of booths for analytics purposes. As such, spectrumization is a process by which a color-coded map of a venue can be created for the venue to facilitate human visualization of various parameters of booths, which can be selected (turned on) or de-selected (turned off) to generate a “value map” visualization.

The location analyzer 218 is intended to represent the actual location of the booth using GPS coordinates.

The booth valuation engine 212 includes a proximity determination unit, a best entrance fixing unit, a best spot fixing unit, a value computation unit and a booth valuation pricing unit. The proximity determination unit computes the distance and estimates the proximity between the main gate of the venue and each entrance of the venue hall using navigation and positioning systems such as but not limited to pedestrian dead reckoning (PDR) methods along with various communication technologies such as Wi-Fi, Radio Frequency Identification (RFID) visible light, Bluetooth ultra-wide band (UWB) and other similar technologies. The best entrance fixing unit, based on the proximity computed by the proximity determination unit, chooses the best entrance amongst the available entrances of the venue hall or the best spot at the venue hall. The value computation unit, based on the determined proximity and the fixed best entrance or the best spot, generates a proximity value for booth valuation. The best spot fixing unit fixes a best spot wherein the best spot is the spot with a positive influence on nearby booths. The booth valuation pricing unit, based on the generated proximity value, determines the price for each booth and it is projected to organizers and prospective exhibitors.

The booth re-valuation engine 214 includes an organization reputation calculation unit, a booth influencer analysis unit, a re-value computation unit, a trend feedback unit and a booth re-valuation pricing unit. The organization reputation calculation unit estimates the reputation of an organization (prospective exhibitors) using data mining techniques by analyzing parameters like but not limited to organization's stock prices, financial statements, public visibility, growth rate, reviews of the organization, brand loyalty and customer loyalty, etc. Based on these various factors, the reputation calculation unit estimates the reputation score of an organization. The booth influencer analysis unit provides factors influencing competitive intelligence or competitive advantage to exhibitors based on a real world customization parameters and venue reactive parameters. The real world customization parameters include but are not limited to positioning booths based on business similarities, personal correlation between booths based on personal contact lists including friends, business correlation between booths including business partnerships, real world assets such as advertising counters, showcases, phone or tablet holders, folding counters, facilitating magnetic technology or velcro technology for roll-up banners, modular plug-in systems, provision of assets based on to be exhibited product category, refreshment counters, workspace, an audio visual system, barcode and QR code scanners, payment devices, fever check cameras, hand sanitizer dispensers, biometric scanners, printers, digital signage, goodies stock or goodies distribution table, providing comfortable seating for visitors etc., individual traffic tracking, environment impacts such as air conditioner temperature in and around the booth, Wi-Fi connectivity in and around the booth, booth lighting, eco-friendly booths that reduce the environmental impact of exhibiting, position of a spot near to a booth. The venue reactive parameter include but are not limited to booth reputation, high visibility, legacy data, etc. The venue reactive parameters such as reputation are obtained from the organization reputation calculation unit or the booth re-valuation engine 214 and high visibility is obtained from the booth valuation engine 212. The booth re-valuation 214 engine uses the reputation score to upsurge and revise or revalue the booth value of an unsold booth based on the inputs from the organization reputation calculation unit and the booth influencer analysis unit. The booth re-valuation pricing unit, based on the generated revised booth value, determines the price for each booth and it is projected to organizers and prospective exhibitors. The trend feedback unit, based on re-valuation over a periodic time interval, generates a trend graph to show the upsurge of a booth value after sale, before the event, and during the event. The trend graph generated by the trend feedback unit is a particularly useful type of feedback to identify and visualize the booth value going up or down over time. The trend feedback unit also provides feedback generated as bar graphs, line graphs, histograms, frequency curves, cone chart, pie chart, multi layer pie chart, donut chart, etc.

The slot wise validity booth determination engine 220 determines booths based on a booth validity. Booths are categorized into persistent booths and slot wise validity booths. The persistent booths are booths with all day validity, i.e., available on all days of the exhibition. The slot wise validity booths are booths available only on specific days of the exhibition. The booth combination suggestion engine 222 provides suggestions to merge slot wise validity booths with persistent booths, slot wise validity booths with another slot wise validity booth based on booth availability using booth combination methods. Persistent booths or slot wise validity booths may or may not be back to back or adjacent, opposite, etc. Booths are merged (e.g., into a combined booth) for efficient utilization of available booths.

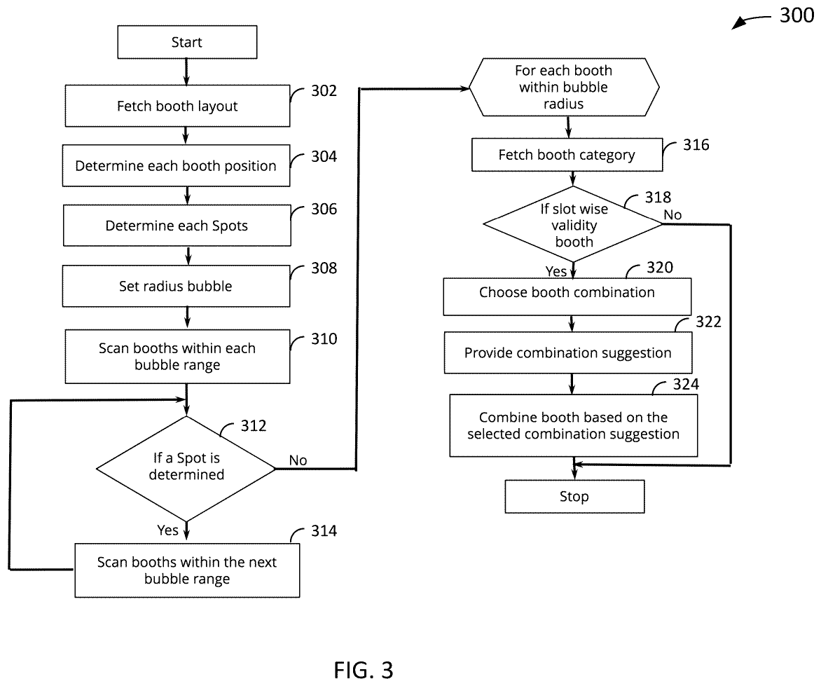

FIG. 3 illustrates a flowchart 300 of an example of a method for booth combination. The booth creation engine 202 fetches the booth layout from the layout engine 204 at module 302. Booth positions are determined at module 304. Spots are fetched from the booth layout at module 306. Spots are non-booth areas in a layout with a positive influence or a negative influence. Bubble radius is set at module 308. Booths within each bubble range are scanned at module 310. If a spot is determined ‘Yes’ within the bubble range at decision point 312, booths within the next bubble range are scanned at module 314 because booth combination is not possible if a spot is determined. If, on the other hand, a spot is determined ‘No’ at decision point 312, for each booth within the bubble radius, the booth category is fetched from the booth creation engine 202 at module 316. Slot wise validity is determined at decision point 318 for a “slot wise validity” booth. If it is determined ‘No’, no further action takes place (and the flowchart ends for illustrative purposes). If it is determined ‘Yes’, booth combination is chosen (e.g., the booth is combined or merged) at module 320; the booth combination suggestion unit provides combination suggestion at module 322; and booths selected based on the suggested combination are merged or combined at module 324, after which the flowchart ends for illustrative purposes. The suggestion is based on the following. The determined slot wise validity booth is combined with an adjacent slot wise validity booth or the determined slot wise validity booth is combined with an adjacent persistent booth. The system facilitates an exhibitor to exhibit multiple sub brands in a persistent booth or a slot wise validity booth. As an example, a booth say ‘M’ is occupied by an exhibitor say brand ‘X’, the brand ‘X’ included sub brands say ‘P,Q,R’. The exhibitors are facilitated to change the booth layout of ‘M’ and exhibit one or all of the sub brands ‘P,Q,R’ of brand ‘X’. The location of sub brands exhibited in booth ‘M’ is easily identified by the visitors using the unique identification. Booth ‘M’ can be one or more persistent booths, one or more slot wise validity booths, or a combination of both.

Spots include but are not limited to Meeting/Conference rooms, Registration desk, Lounge area, Entrance, Exit, Sanitizer station, Water dispenser, Food Area, Coffee Bar, Emergency exit, Elevator, Restrooms, First aid box, Fire extinguisher cylinder, Charging point, Restaurant and Stairs. Spots that pull crowd or visitors have a positive influence on walk-in for the neighborhood booths. Spots that are least crowded or with the least visitors have a negative influence on walk-in for the neighborhood booths. A neighborhood booth is a booth that is adjacent to or opposite a first booth. A neighborhood booth can also be near a first booth, separated by one or more intervening booths. For example, a neighboring booth could be in the same aisle as a first booth separated by one or more intervening booths or along a same path within a venue. It may be noted that adjacent booths that are back-to-back may or may not be considered “adjacent” for the purpose of whether they are neighboring. For example, if a first booth and second booth are back-to-back, they may not be near the same access path. In general, proximity, visibility, and/or ease of accessibility relative to one another is determinative of a neighboring relationship.

Combined booths are re-valued by the booth re-valuation engine 214. The re-value computation unit, based on reputation value, re-values the unsold booths. The booth re-valuation pricing unit, based on the re-valuation, determines the price for unsold booths and it is projected to organizers and prospective exhibitors.

The data store 216 facilitates storing and retrieving booth valuation, booth re-valuation, legacy data, booth pricing for corresponding booth supplies and booth related information from the booth creation engine 202, the booth layout engine 204, the location analyzer 218, the slot wise validity booth determination engine 220, the booth combination suggestion engine 222, the booth sales and supply monitoring engine 206, the spectrumization engine 208, the booth valuation engine 212, the booth re-valuation engine 214, the virtual booth parameter configuration engine 210. The data store 216 can have a corresponding engine to create, read, update, or delete (CRUD) data structures. While not shown in FIG. 2, these engines may or may not be described in association with other figures to illustrate relevant functionality. Data structures can include fields, records, files, objects, and any other applicable known or convenient structures for storing data. a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The data stores, described in this paper, can be cloud-based data stores. A cloud-based data store is a data store that is compatible with cloud-based computing systems and engines.

Legacy data are past event history including human inflow data, obtained booth valuation and re-valuation say on ‘Day 1’ or on ‘Day 2’ of an ongoing event or from a past event, past event footfalls, feedback or surveys from exhibitors or visitors. The system uses the legacy data to evaluate current factors influencing valuation and to forecast future operations. Based on the legacy data, the system forecasts the booths with high visibility, possible hike in booth pricing, required manpower or resources, real world assets, placement of spots, most opted booth by exhibitors, human inflow, presence of exhibitor brands with high reputation and associated influential factors. The influential factors include but are not limited to the temperature in and around the booth area, accessibility to spots, availability of real world assets, connectivity to Wi-Fi, etc. The forecasts can be influential factors for valuation of the booths in the future.

As an example, using legacy data, the system fetches the booths A,B,C,D occupied by exhibitors' brands W,X,Y,Z with a high reputation value weightage and the associated factors that influenced the brands to occupy the booths. W,X,Y,Z may have occupied the booth for easy access to spots. For a future event, the system predicts the booths with the same or additional influential factors, and provides a suggestion to prospective exhibitor brands W,X,Y,Z.

The virtual booth parameter configuration engine 210 enables organizers to build interactive experiences that combine the virtual environment and the real world for the exhibitors. The virtual booth parameter configuration engine 210 provides extended reality experiences for the organizers and the exhibitors, and enables exhibitors to perceive original appearances of exhibits with real world asset models and other booth influential parameters. Original appearance of exhibits or legacy data such as a footfall of a booth is recreated in the virtual environment. Based on the extended reality experience, a prospective exhibitor selects booths with one or more influencing parameters which they experience in the virtual environment. The valuation or the re-valuation of the booth is affected by this selection. As an example, a prospective exhibitor selects real world assets such as refreshment counters, workspace or an audio visual system for a specific booth. The prospective exhibitor perceives the original appearance and feel of the selected assets for the specific booth via virtual environment. Based on the selected asset via virtual environment, valuation or re-valuation is done on the specific booth and the price of the booth is altered.

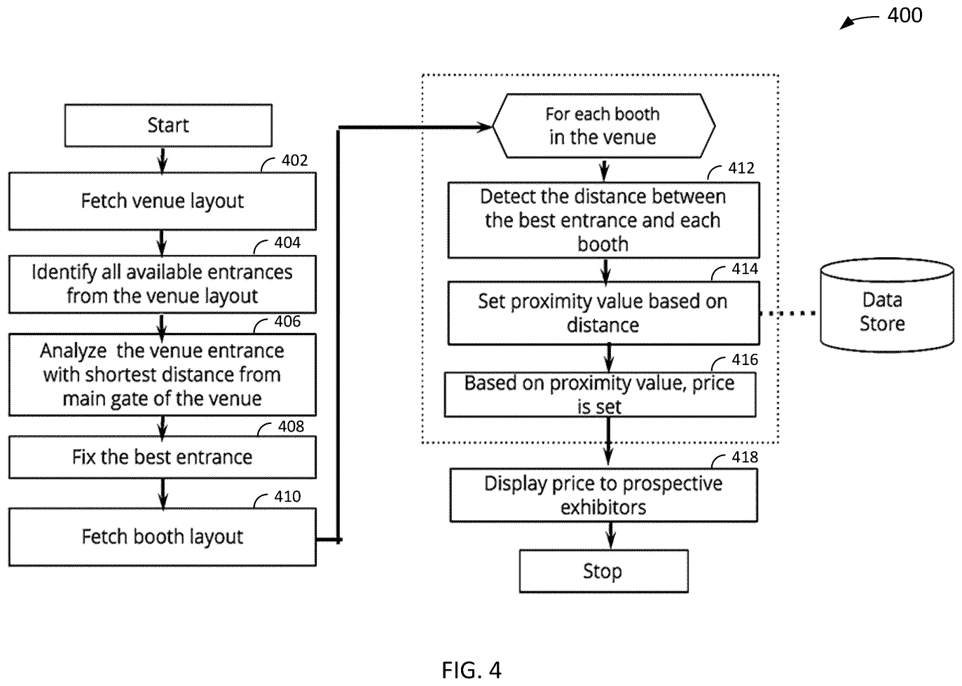

An exhibition has any number of booths. FIG. 4 depicts a flowchart 400 of an example of a method to determine proximity value of each booth before sale. The booth valuation engine 212 determines the proximity value of each booth area on the layout at module 402. Available entrances are identified from the venue layout at module 404. Valuation of the booth by fixing the best entrance is initiated by determining the proximity from a main gate of a venue to an entrance of a venue hall at module 406. The entrance with a shortest proximity from the main gate is fixed as a best entrance at module 408. Later, booth layout is fetched at module 410 and the distance from the fixed best entrance to each booth in the venue hall is detected at module 412. A proximity value corresponding to the distance is assigned to each booth at module 414. The proximity values corresponding to a distance are preset by the organizers and accessed from the data store at module 414. The shorter the distance from the fixed best entrance, the higher the proximity value of the booth. Since the distance is short from the venue entrance, it has high visibility and is easy to access by the visitors at the exhibition. Hence high proximity values are assigned to booths with the shortest distance from the fixed entrance. Once proximity values are determined and fixed, the system will set a price to the determined proximity value at module 416. The price is obtained from a list with a price range for each proximity value which is preset by the organizers using a pricing unit. So, the booth will automatically be assigned the price based on the proximity value. Prices are displayed to prospective exhibitors at module 418. In an alternative, the entrance with highest human inflow is fixed as the best entrance.

To implement the method, the system fetches the venue layout (as described above with reference to module 402). It identifies available entrances from the venue layout. The system identifies the shortest distance from the main gate to the entrance of the venue hall. Among all the entrances in the venue, the entrance identified as shortest distance is fixed as the best entrance. Later, the system fetches the booth layout (as described above with reference to module 410). For each booth in the venue, the distance between the fixed best entrance and the booth is determined. A proximity value is set for each booth based on the determined distance. At the next step, a price is set based on the proximity value of each booth. The set price of each booth is displayed to prospective exhibitors for sale. In an alternative, the set price is displayed to the organizers of the exhibition. By default, the determined value of each booth by either using proximity measure or human inflow metrics, is stored in a data store.

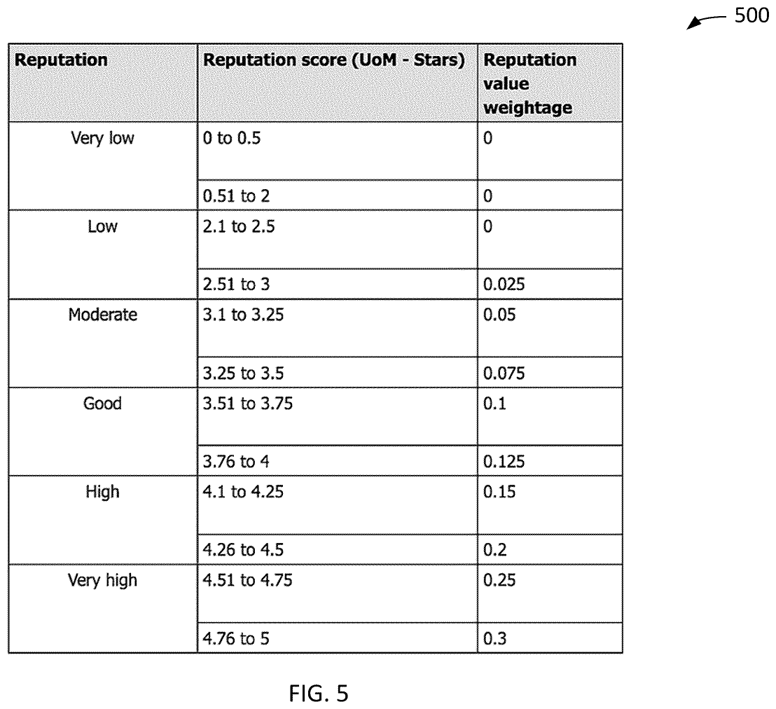

Re-valuation is performed to upsurge an unsold booth value, wherein the unsold booth value referred to here is the proximity value obtained before re-valuation. Upsurge or a hike in the price or value of each unsold booth is determined. FIG. 5 depicts tabulated values of an organization reputation score and its corresponding reputation value weightage in diagram 500. When one or a plurality of booths are sold based on FIG. 4, the reputation of the sold booth impacts its unsold neighborhood booths. Re-valuation of an unsold booth is performed by comparing an adjacent and an opposite sold booth value. The information of adjacent and opposite relative booth positions is fetched from the booth creation engine 202 and the layout engine 204. On comparing the adjacent and opposite sold booth values, the booth with higher value is picked and its reputation value weightage is obtained. The reputation value weightage is predetermined. The reputation value weightage is obtained by considering reputation level and its corresponding reputation score of the organization is evaluated, as explained in Table 1. In table 1, the reputation level of the organization is categorized from very low, low, moderate, good, high to very high and its corresponding reputation score and reputation value weightage is added and stored. The obtained reputation value weightage is used to revalue the unsold booth area. The obtained reputation value weightage along with the sold value of the picked sold booth is added to the proximity value of the unsold booth, thereby upsurging the unsold booth value. Thus, a revised value or a re-valued value is obtained for each of the unsold booths based on the reputation of the sold neighborhood booth. The obtained revised value is stored in a data store. Based on the obtained revised value of the unsold booth, the system will modify the current price assigned to the unsold booth. Modification of the current price is dynamically performed. Thus, a new price is set to the determined revised value of the unsold booth from the re-valuation pricing unit. The set price is displayed to prospective exhibitors for sale. The new price is obtained from a list with a price range for each value which is predetermined by the organizers using the booth re-valuation pricing unit. For example, a predetermined price list includes a first predetermined price for booths that have a valuation within a first specified range and a second predetermined price for booths that have a valuation within a second specified range. In a specific implementation, the predetermined price list is used for both valuation and re-valuation.

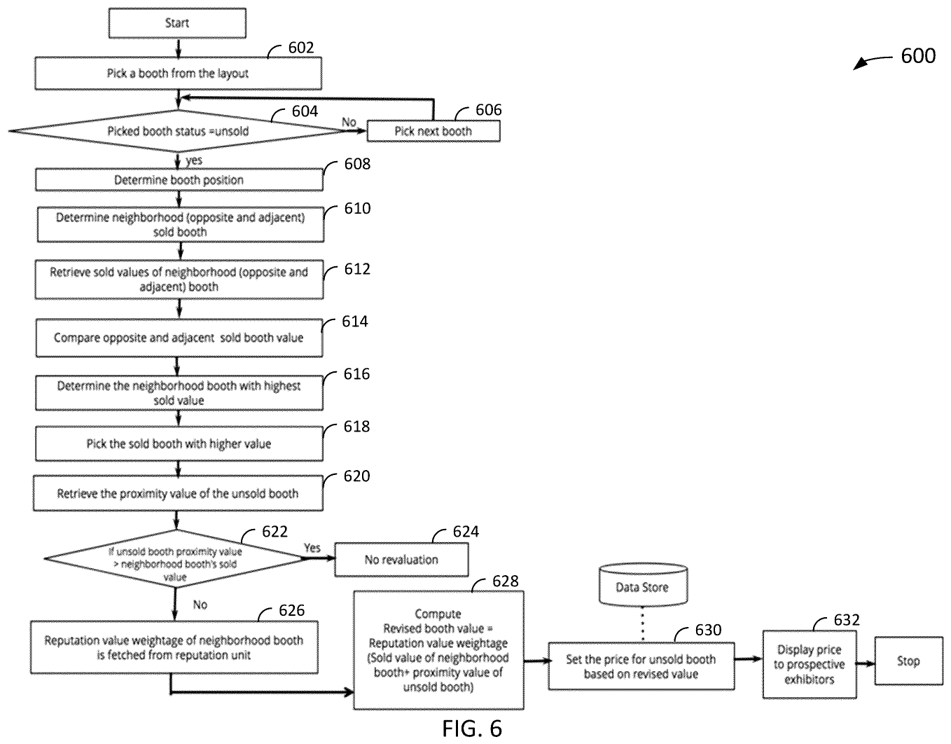

FIG. 6 depicts a flowchart 600 of an example of a method for re-valuation of an unsold booth.

In a specific implementation, the method determines a revised value of each unsold booth after the sale of neighborhood booth. The flowchart starts at module 602 with picking a booth, e.g., from the booth creation engine 202 and the layout engine 204. The status of the booth can be fetched from the booth sales and supply monitoring engine 206. If it is determined at decision point 604 that the status of the booth is not unsold, a next booth is picked at module 606 and the flowchart returns to decision point 604 with for the next booth. If the status of the picked booth is unsold, booth position is determined at module 608. The sold neighborhood booth position is determined at module 610. Sold values of the neighborhood opposite and adjacent booths are retrieved from a data management unit at module 612. The retrieved sold values of opposite and adjacent booths are compared to find the higher sold value at module 614. The sold booth with highest value is determined at module 616. After picking the sold both with highest value at module 618, the proximity value of the unsold booth is retrieved at module 620. The determined proximity value of the unsold booth is compared with the sold value of the picked neighborhood booth. If it is determined at decision point 622 that the proximity value of the unsold booth is greater than the sold value of the picked neighborhood booth, then the system retains the proximity value of the unsold booth and no re-valuation is performed (and the flowchart ends at 624 for illustrative purposes). If, on the other hand, it is determined that the proximity value of the unsold booth is less than the sold value of the picked neighborhood booth, then the system proceeds with the re-valuation of the unsold booth; the reputation value weightage of the picked sold neighborhood booth is fetched from the organization reputation calculator unit at module 626. The fetched reputation value weightage is added and computed to the sold value of the picked neighborhood booth and the proximity value of the unsold booth. The revised value or final value is obtained by computing Reputation value weightage (current value of sold booth+current value of unsold booth) at module 628. Based on the revised value, a new price is set for the unsold booth at module 630. The price is obtained from a price range for each value which is preset by the organizers using the re-valuation pricing unit. So, the booth will be automatically assigned a price based on the re-valuation of the unsold booth and the set price is stored in a data store. The price is then displayed to prospective exhibitors and organizers at module 632 (and the flowchart ends for illustrative purposes).

As indicated above with reference to module 606, if it is determined that the status of the booth is sold, the system picks the next booth for valuation. In a specific implementation, if there are no sold booths adjacent or opposite to the unsold booth, no re-valuation takes place. If only one of the neighborhood (either the adjacent booth or the opposite booth) is sold, the system picks the sold booth for the computation. The system will pick the booth in a particular order or not any particular order to check the status of the booth for re-valuation. In an alternative, the system picks the adjacent or opposite neighborhood booth of the first sold booth. The revised value obtained from the fetched reputation value weightage can be removed or added based on user preferences. The said booth area valuation is applied for booths that are merged using booth combination methods. Based on the disclosed booth valuation method, each booth is categorized and projected to prospective exhibitors.

In an alternative, re-valuation is also based on influencing factors of the real world customization parameters in real time. Influencing factors are attributed to a variety of factors including but not limited to business similarities, partnerships, preferred contact lists of exhibitors, real value assets, environmental circumstances such as an air conditioner temperature in and around the booth, Wi-Fi coverage in and around the booth. A composite value is obtained by calculating the influencing factors and it is used for obtaining the revised booth value. Revised value is obtained by computing reputation value weightage of sold booth, composite value of the unsold booth, sold value of neighborhood booth and the proximity value of unsold booth.

The disclosed re-valuation method is reiterated over a periodic interval of time to deduce the upsurge value of a booth after it is being sold, before the event, and during the event. The trend feedback unit projects the upsurge in booth value to the corresponding exhibitor who has occupied the booth. This upsurge booth value is projected to the corresponding exhibitor to highlight the perks or benefits of the respective booth. The re-valuation of the sold booth is initiated once the booth is sold and is reiterated until the last day of the event based on a periodic interval of time. The periodic interval of time is predetermined.

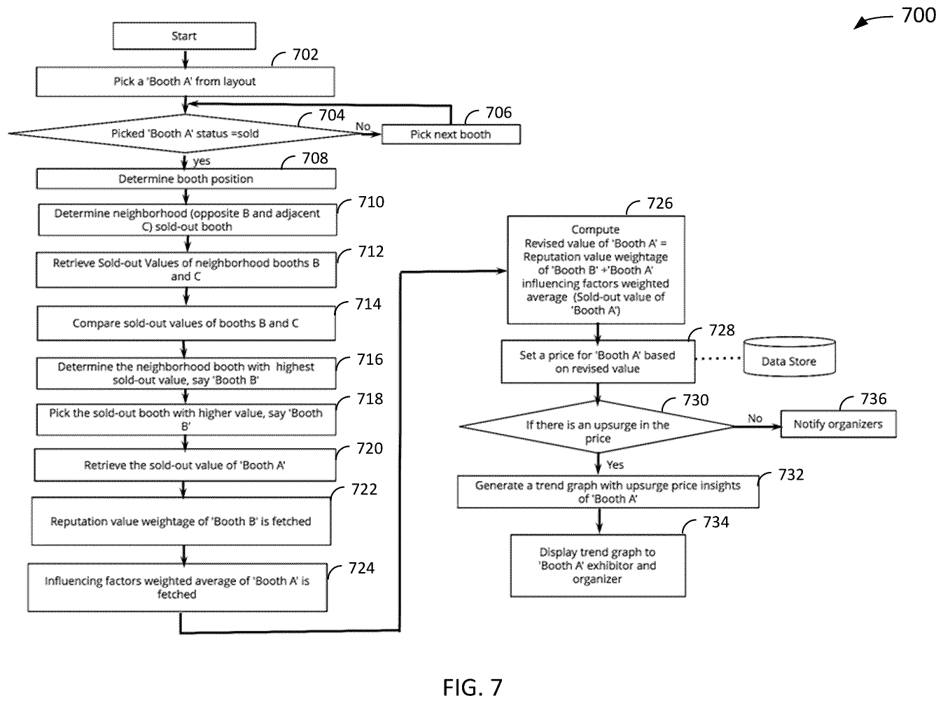

FIG. 7 depicts a flowchart 700 of an example of a method for re-valuation of a sold booth. The system picks a ‘Booth A’ from a layout at module 702. The status of the ‘Booth A’ is checked. If it is determined at decision point 704 that the status of the picked ‘Booth A’ is not sold, a next booth is picked at module 706 and the flowchart returns to decision point 704. If the status of the picked ‘Booth A’ is sold, ‘Booth A’ position is determined at module 708. The sold neighborhood (opposite, say ‘Booth B’ and adjacent, say ‘Booth C’) booth position is determined at module 710. The sold values of the neighborhood booths ‘B & C’ are retrieved at module 712. The retrieved sold values of ‘B & C’ booths are compared to find the higher sold value at module 714. The sold booth with higher value is determined, say ‘Booth B’, at module 716. The sold ‘Booth B’ is picked at module 718. The sold value of ‘Booth A’ is retrieved at module 720. Reputation value weightage of ‘Booth B’ is fetched using the organization reputation calculation unit at module 722. Composite value of ‘Booth A’ is fetched at module 724. The revised value of ‘Booth A’ is obtained by computing ‘Reputation value weightage of ‘Booth B’+‘Booth A’ composite value (Sold value of ‘Booth A’)’ at module 726. A price is set for ‘Booth A’ based on revised value and stored in a data store at module 728. If there is an upsurge in the price at decision point 730, a trend graph is generated with upsurge price insights of ‘Booth A’ at module 732 and the generated trend graph is displayed to the ‘Booth A’ exhibitor and organizers of the event at module 734 (and the flowchart ends for illustrative purposes). If there is no upsurge in the price, then the organizers are notified about the revised value, in this case a depleted value of ‘Booth A’, at module 736.

The system detects real time anomalies based on influential factors of ‘Booth A’ and analyzes influencing factors for the depletion of ‘Booth A’ value, and notifies organizers in real time with suggestions on improving the influential factors of ‘Booth A’. As an example, the system identifies the depletion of ‘Booth A’ value is due to a weak Wi-Fi signal. The system notifies the organizers and suggest an ideal signal strength for better connectivity in real time, i.e., during the event. The system may also use this information for an early detection of anomalies based on influential factors and providing valuable insights for future operations. As an example, in the future the system may forecast or predict a booth value, say ‘Booth D’ in advance. If the influential factors of ‘Booth D’ are similar to the influential factors of ‘Booth A’, the system may predict the value of ‘Booth D’ or notify organizers with a suggestion to improve the value of ‘Booth D’ in advance.

To deduce the upsurge value of the booth after it is being sold, before the event, and during the event, the system may use reputation value weightage or composite value or both.

The above mentioned systems and methods for valuation or re-valuation are applied on but are not limited to persistent booths, slot wise validity booths, combination booths, booths near to spots, etc.

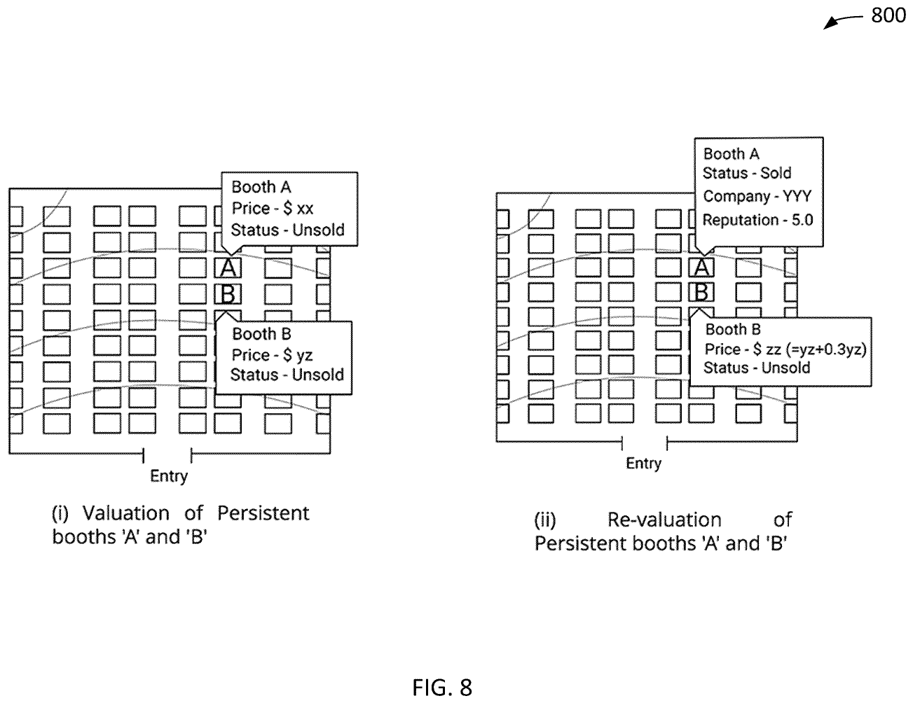

FIG. 8 depicts a conceptual screenshot 800 for valuation and re-valuation of persistent booths. In FIG. 8, valuation of persistent booths ‘A’ and ‘B’ are based on FIG. 4. Assuming that persistent booth ‘A’ is sold, re-valuation is performed to upsurge the proximity value of ‘B’ based on the reputation of sold booth A as depicted in FIG. 8. ‘ZZ’ denotes the new price and ‘YZ’ denotes the old value of the booth B. The re-valuation is performed as illustrated in FIG. 6.

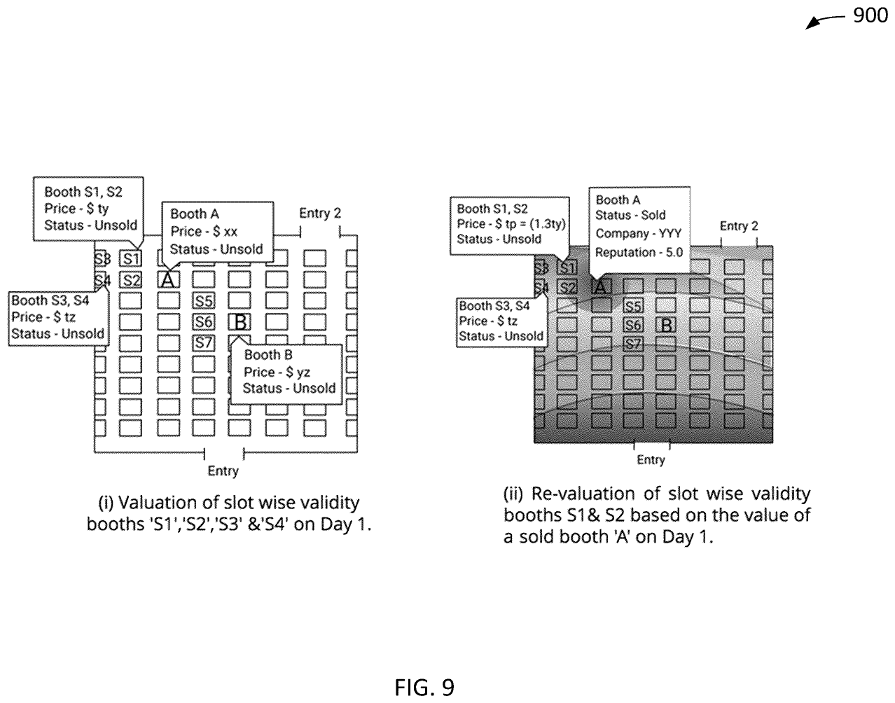

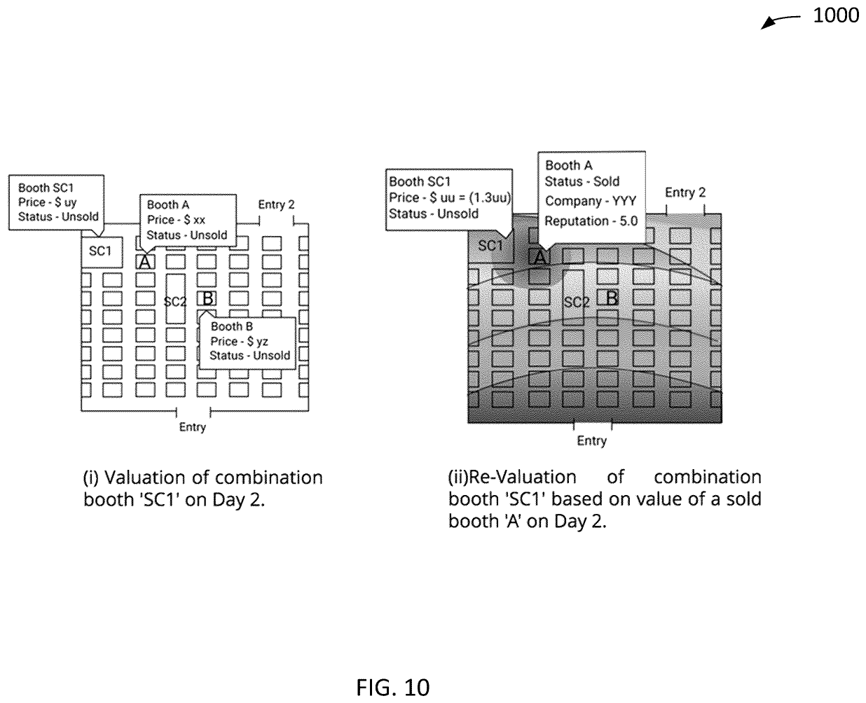

FIG. 9 and FIG. 10 illustrate the valuation and re-valuation of slot wise validity booths before and after combination. As an example, an organizer needs all the slot wise validity booths (S2-S7) available individually on the 1st day of the exhibition and as combo (S1,S2,S3,S4 as SC1 & S5,S6,S7 as SC2) on the 2nd day. ‘SC1’ is a combination of ‘S 1’, ‘S2’, ‘S3’ and ‘S4’. ‘SC2’ is a combination of ‘S5’, ‘S6’ and ‘S7’.

FIG. 9 depicts a conceptual screenshot 900 for valuation and re-valuation of slot wise validity booths on Day 1. On Day 1, the valuation of slot wise validity booths S1,S2,S3,S4 is based on FIG. 4. Assuming the persistent booths (A & B) are sold, the impact of A booth sold value on S1,S2 for re-valuation is based on FIG. 6.

FIG. 10 depicts a conceptual screenshot 1000 for valuation and re-valuation of combination booths on Day 2. On Day 2, the valuation of combination booth SC1 is based on FIG. 4 provided neighboring persistent booth ‘A’ is unsold. Assuming the persistent booths (A & B) are sold, the impact of A booth sold value on SC1 for re-valuation is based on FIG. 6 and vice versa if booth ‘SC1’ is sold and booth ‘A’ is unsold, re-valuation of unsold ‘booth A’ is based on reputation of booth ‘SC1’ as illustrated in FIG. 6.

On Day 2, changing the booth settings such as the real world assets for a combination/slot wise validity booth is difficult and time-consuming for the exhibitors or the organizers. The advantage with combination booths or slot wise is that booth setting will be dynamically changed by the system. As an example, on Day 2 the system dynamically changes a digital brand asset say signage, associated to ‘Booths SC1 and SC2’.

The ‘Booth SC1’ value is dynamically revised for ‘Day 2’ during the event based on the composite value of slot wise validity booths S1,S2,S3,S4 and reputation weightage of ‘Booth A’ on Day 1. The composite value of slot wise validity booths S1,S2,S3,S4 and reputation weightage of ‘Booth A’ on Day 1 are stored as legacy data in the data store. The booth re-valuation 214 engine fetches the composite value of slot wise validity booths S1,S2,S3,S4 and reputation weightage of ‘Booth A’ from the data store to dynamically revise the ‘Booth SC1’ value on Day 2.

Based on the proximity value obtained from valuation and the revised or re-valued value obtained from re-valuation, booths with high visibility, competitive booths, booths that are located near to high visibility spots is determined and projected to prospective exhibitors or users based on the exhibitor preference.

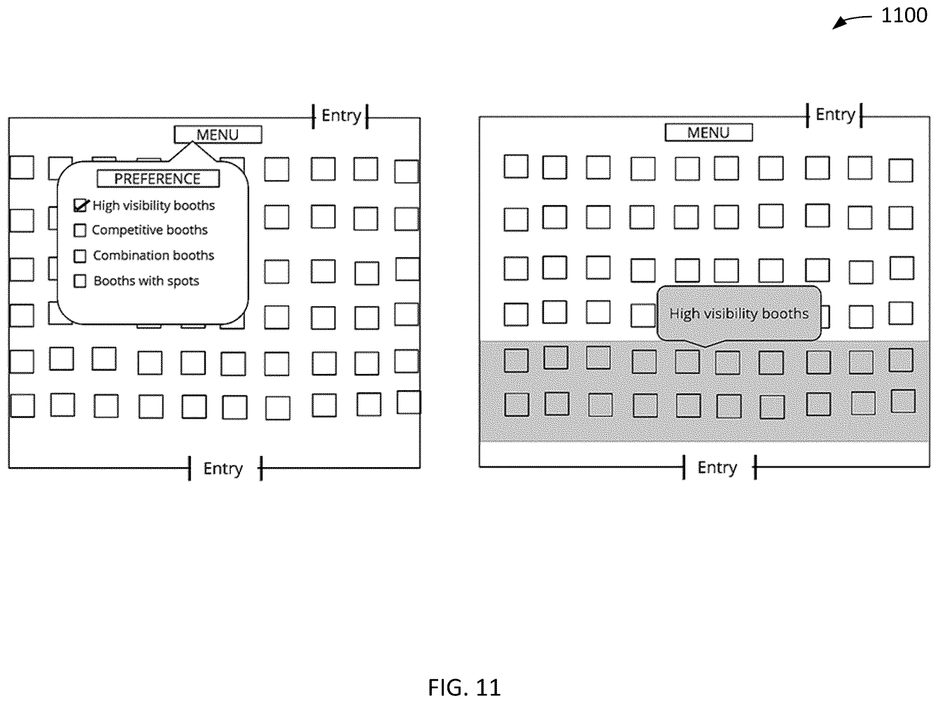

FIG. 11 depicts a conceptual screenshot 1100 illustrating a display of high visibility booths based on exhibitor or user preference. FIG. 11 illustrates display of high visibility booths based on exhibitor or user preference. As illustrated in FIG. 11, the system receives a request to display booths with high visibility from prospective exhibitors. The booth management subsystem fetches the proximity value. Booths with higher proximity value are high visibility booths. The booth management subsystem, based on proximity value, spectrumizes the high visibility booths and displays it to prospective exhibitors.

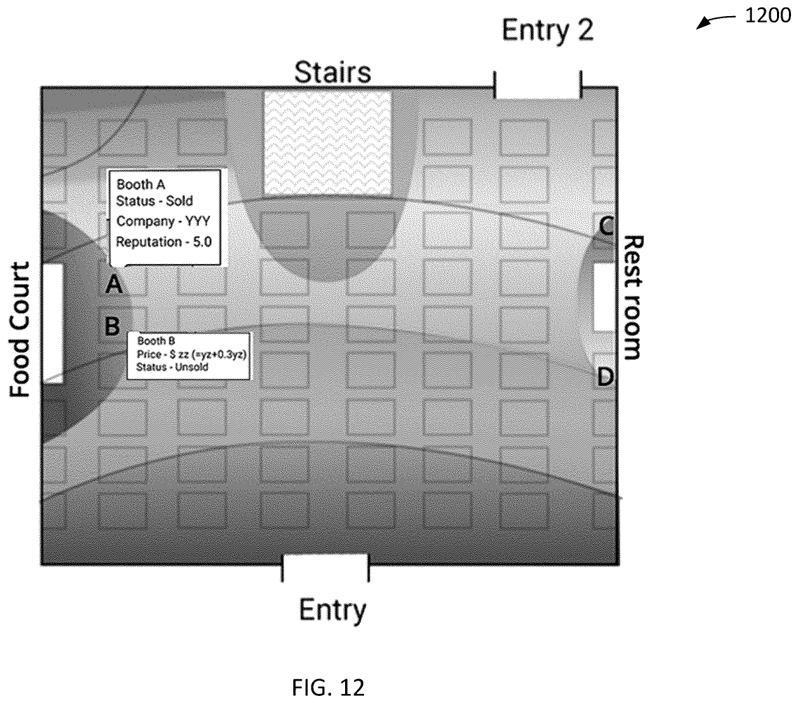

FIG. 12 depicts a conceptual screenshot 1200 illustrating a display of booths located near spots. The spectrumization engine 208 spectrumizes the booth based on the neighborhood spots. FIG. 12 illustrates the spots with high visibility and positive impact, and the spots with low visibility and negative impact. In FIG. 12, the spot ‘Food Court’ is considered to have positive impact as it is assumed to attract visitors thereby increasing the walk-in in nearby booths. Hence booths ‘A’ & ‘B’ are considered to be high visibility booths. Spot ‘Restroom’ is considered to have a negative impact as visitors may not attend nearby booths. Hence booths ‘C’ & ‘D’ are considered to be low visibility booths.

For valuation, the distance between a positive impact spot and each booth is considered as Proximity value. The positive impact spot is also referred to as the best spot. The best spot or the positive impact spot is determined by the best spot fixing unit. Re-valuation is based on FIG. 6. When there is more than one positive impact spot or negative impact spot, the spectrumization engine 208 spectrumizes the booths within a radius near to the spot and then computes the valuation. Booths with high proximity value near the positive impact spot are displayed to the user.

Booths based on influencing factors is determined by the real world customization parameters and the venue reactive parameters. The real world customization parameters include booths with business similarities or booths exhibiting similar products, personal correlation between booths based on personal contact list including friends, business correlation between booths including business partnerships, real world assets, individual traffic tracking, temperature in and around the booth, Wi-Fi connectivity in and around the booth. After determining the influencing factors based on a real world customization parameter, the influencing factors of the venue reactive parameter such as booth reputation or visibility can also be applied on the real world customization parameter.

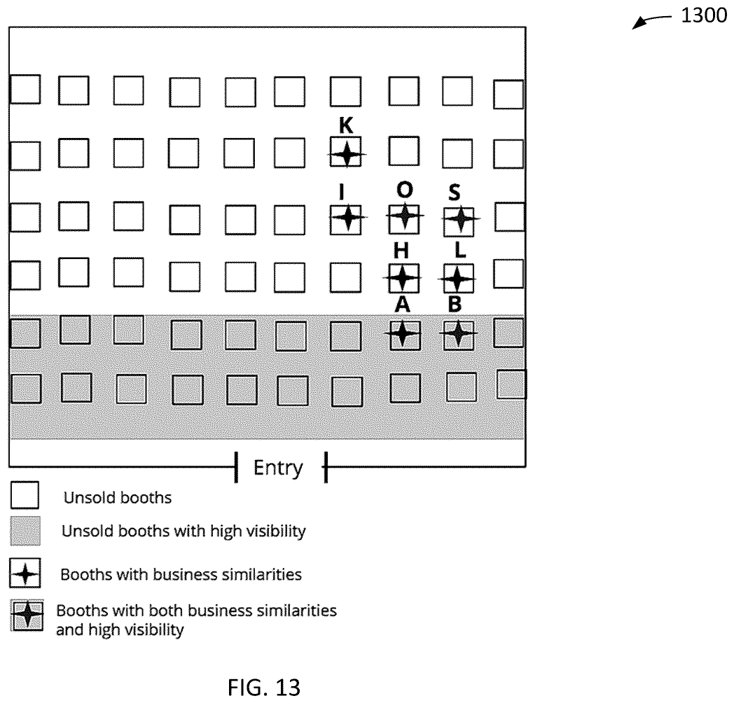

FIG. 13 depicts a conceptual screenshot 1300 for facilitating determination of booths based on a real world customization and a venue reactive parameter. As an example, a prospective exhibitor would like to purchase a booth based on business similarities, such as marketing similar products or goods. The system determines the booth with business similarities based on the business profile of the prospective exhibitor. The system fetches the business profile of the prospective exhibitor or other exhibitors from a data store or from an in house application. For example, ZOHO CRM application is used to fetch business profile, contacts of prospective exhibitors and other exhibitors who already own a booth. Based on the fetched profile, the system determines the similarities and displays it to the prospective exhibitor. In FIG. 13, ‘Booths A,B,H,L,I,O,S,K’ have business similarities that match with the business profile of the exhibitor. In addition ‘Booths A and B’ are booths with business similarities in high visibility range. Unsold booths and unsold booths with high visibility are illustrated in the FIG. 13.

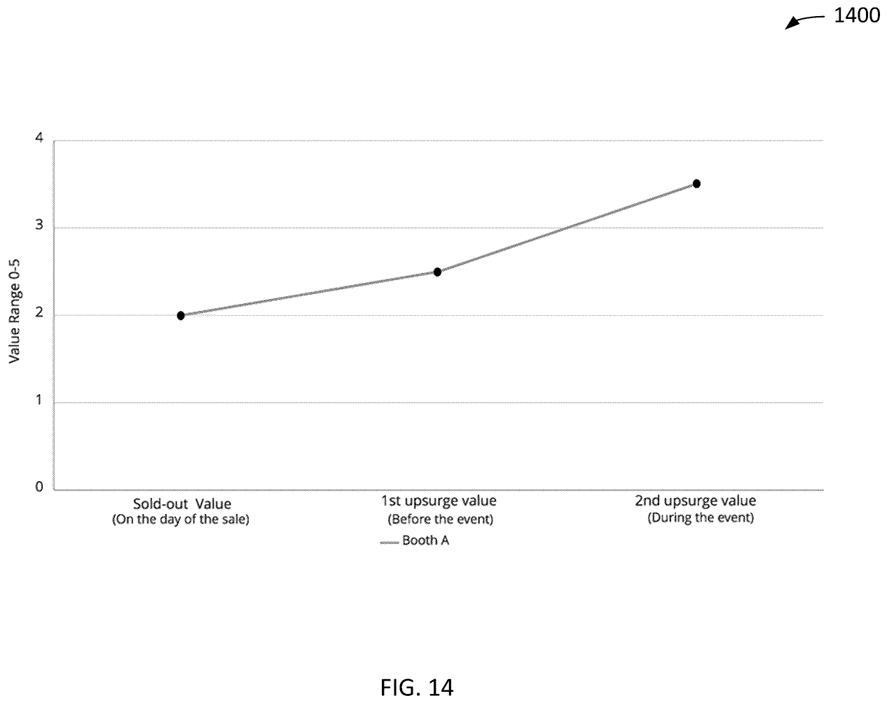

FIG. 14 illustrates a trend graph 1400 that illustrates a feedback of an upsurge booth value to an exhibitor based on re-valuation over a periodic time interval. From trend graph 1400, let's say ‘Booth A’ was sold on 20 Jun. 2023 to an exhibitor. The sold value of ‘Booth A’ on the day of the sale is ‘2’ and its corresponding price, say 20K INR. A week later, before the event, the system determines the revised value of ‘Booth A’ as illustrated in FIG. 7, and the revised value of ‘Booth A’ is ‘2.5’ and its corresponding price, say 30 k INR. On the day of the event or during the event, the revised value of ‘Booth A’ is ‘3.5’ and its corresponding price, say 40K INR. There is an upsurge in value based on the reputation of the neighboring booth and based on the real world customization parameters that influences competitive advantage of ‘Booth A’. The real world customization parameters are real time or dynamic.

The disclosed valuation and re-valuation methods are also applied to area valuation and re-valuation of booth spaces in a virtual environment. The area valuation and re-valuation methods are also applied on various areas such as but not limited to malls, restaurants.

The proximity values and revised values of booths are stored and studied by the system and also used for other events conducted in the future. Also in the same venue, the bias caused due to the booth sales is studied for further analysis and used as a factor for suggesting booth valuation suggestions for the next event in the same place.

What is claimed is:

1. A computer implemented method comprising:
providing a venue layout that includes a representation of booths and spots in a venue, wherein a spot is a non-booth area;
determining a first proximity value for a first booth and a second proximity value for a second booth in the venue layout, wherein the first proximity value is based at least in part upon proximity to an entrance to the venue for the first booth and the second proximity value is based at least in part upon proximity to the entrance to the venue for the second booth;
assigning a first price from a predetermined price list to the first booth based at least in part on the first proximity value and a second price from the predetermined price list to the second booth based at least in part on the second proximity value;
determining that the first booth is sold and the second booth is unsold;
revaluing the second booth, based on a reputation value weightage of the first booth, wherein the second booth is a neighborhood booth of the first booth;
assigning a revised price to the second booth from the predetermined price list, based on the revaluing;
providing the revised price to an exhibitor, an organizer, or both.

2. The method of claim 1 comprising revaluing the second booth, based on a composite value of the second booth.

3. The method of claim 1 comprising revaluing the second booth based on a reputation value weightage of the first booth, wherein the second booth is positioned adjacent or opposite to the first booth.

4. The method of claim 1 comprising storing the proximity value and the value from revaluing the second booth as legacy data.

5. The method of claim 1, wherein the proximity value of the first booth is determined by proximity to a first entrance, comprising:
identifying available entrances, including the first entrance, from the venue layout;
analyzing distance from a main gate of the venue for the available entrances;
defining the first entrance as a best entrance when the first entrance has a shorter distance from the main gate than other entrances of the available entrances;
determining the first proximity value for the first booth based on proximity of the first booth to the best entrance and the second proximity value for the second booth based on proximity of the second booth to the best entrance;
obtaining a price from the predetermined price list, based on the calculated proximity value for the first booth.

6. The method of claim 1, wherein a best entrance is defined using human inflow information from legacy data, wherein an entrance with highest human inflow is defined as the best entrance.

7. The method of claim 1, comprising:
picking the second booth from the venue layout;
determining status of the second booth is unsold;
determining a booth position for the second booth;
determining neighborhood sold booths of the second booth, wherein the neighborhood sold booths are opposite and adjacent to the second booth;
retrieving sold booth values of the determined opposite and adjacent neighborhood booths;
comparing the retrieved sold booth values of the opposite and adjacent neighborhood booths;
determining and picking a highest sold value booth of the opposite and adjacent neighborhood booths;
retrieving a proximity value of the second booth;
examining the proximity value of the second booth and the picked highest sold value booth, and when the proximity value of the selected unsold second booth is lesser than the picked sold booth value, fetching reputation value weightage of the sold booth;
obtaining a revalued value by summing the fetched reputation value weightage with the proximity value of the second booth and the determined highest sold value of the sold booth;
assigning a revised price for the second booth based on the revalued value.

8. The method of claim 1, comprising determining a proximity value of a third booth positioned close to a spot, wherein the spot has a positive influence on neighboring booths and the proximity value of the third booth is based on proximity to the spot.

9. The method of claim 1, wherein an upsurge value for the first booth is determined before an event and during the event on a predetermined periodic interval of time based on a reputation value weightage of a sold third booth and influencing factors of the first booth.

10. The method of claim 1, wherein a trend graph is generated for an upsurge value and is displayed to the exhibitor, wherein the exhibitor is associated with the first booth.

11. The method of claim 1, wherein a depleted value is determined, factors influencing the depleted value for the first booth are identified, and improvements influencing factors are provided to the organizers.

12. The method of claim 1, comprising determining a combined booth, wherein the combined booth is selected from a group consisting of a persistent booth, a slot wise validity booth, multiple slot wise validity booths, and a persistent booth and one or more slot wise validity booths.

13. The method of claim 12, further comprising a method for dynamically revaluing values of the combined booth during the event based on composite value of the combined booth and reputation weightage of a neighboring booth.

14. The method of claim 1, wherein an influencing factor includes a real-world customization parameter and a venue reactive parameter.

15. The method of claim 1, wherein booths can be determined based on a real-world customization parameter of an influencing factor or venue reactive parameter of the influencing factor or both.

16. The method of claim 1 comprising revaluing the second booth, based on configured parameters of a virtual booth wherein the configured parameters include real world customization parameters and venue reactive parameters.

17. A system comprising:
means for providing a venue layout that includes a representation of booths and spots in a venue, wherein a spot is a non-booth area;
means for determining a first proximity value for a first booth and a second proximity value for a second booth in the venue layout, wherein the first proximity value is based at least in part upon proximity to an entrance to the venue for the first booth and the second proximity value is based at least in part upon proximity to the entrance to the venue for the second booth;
means for assigning a first price from a predetermined price list to the first booth based at least in part on the first proximity value and a second price from the predetermined price list to the second booth based at least in part on the second proximity value;
means for determining that the first booth is sold and the second booth is unsold;
means for revaluing the second booth, based on a reputation value weightage of the first booth, wherein the second booth is a neighborhood booth of the first booth;
means for assigning a revised price to the second booth from the predetermined price list, based on the revaluing;
means for providing the revised price to an exhibitor, an organizer, or both.
